(19) United States
(12) Patent Application Publication
(10) Pub. No.: US 2006/0147357 A1
(43) Pub. Date: Jul. 6, 2006

(54) Thin film tube reactor

(75) Inventor: Philip Leveson, Hannawa Falls, NY (US)

Correspondence Address: HISCOCK & BARCLAY, LLP, 2000 HSBC PLAZA, ROCHESTER, NY, 14604-2404, US

(73) Assignee: NextGen Chemical Processes Inc.

(21) Appl. No.: 11/322,853

(22) Filed: Dec. 30, 2005

Related U.S. Application Data
(60) Provisional application No. 60/640,604, filed on Dec. 31, 2004.

(51) Int. Cl. B01J 19/00; B01J 8/06

(52) U.S. Cl. 422/224; 422/312; 422/198

(57) ABSTRACT

The invention provides a thin film tube reactor, including an elongate tube that is rotatable about its longitudinal axis. A mixing plate rotatable about the tube's longitudinal axis may be positioned within the tube near the inlet. A plurality of fluid process components are fed into the tube and directed toward the mixing plate. In the absence of the mixing plate, the process components are directed toward the inner surface of the tube. Heating and cooling elements surround the tube to control the process temperature at particular points along the tube. A structured surface that is integral with or affixed to the inner surface of the tube immobilizes a catalyst slurry applied to the inner surface. A separation reservoir includes an end plate with a plurality of radially spaced outlet ports for controlling the output of the products from said separation reservoir.

### FIELD OF THE INVENTION

This invention relates to chemical reactors and thermal processing equipment.

### BACKGROUND OF THE INVENTION

A common problem in chemical reaction processes is how to achieve the proper hydrodynamics in the reactor to efficiently produce the desired products. The reactants must be mixed so that the molecules of the reaction components come into contact with the other components in the reaction including catalysts. The presence of a gaseous reactant requires the increase of the surface area of the boundary between the gas and the liquid components to increase the efficiency of the reaction. Many processes require fine temperature control or added energy from an electromagnetic field. In some cases rapid temperature changes are desired though difficult to achieve due to the thermal inertia of the reaction components. Also, it is often difficult to ensure proper saturation of the reaction components by an electromagnetic field as the outermost portion of the mixture of reactants tends to be exposed to more radiation than the innermost portion.

Thin film reactors are known to overcome many of these issues however an improved thin film reactor is needed. For example, techniques are known for applying a catalyst to a surface for use as a thin film reactor to thereby provide improved contact with the process components. Such techniques include sol-gel or washcoating, which can be used to adhere a catalytically active coat onto the inner wall of a reactor. However, these coats tend to suffer from attrition and will inevitably deactivate with time. Further, there a number of patents in the art that attempt to address some of the above issues are described below.

U.S. Pat. No. 6,742,774 to Holl discloses a reactor that produces a gas-in-liquid emulsion for providing increased interfacial contact area between the liquid and the gas for-improved-reaction of the gas with the liquid, or more rapid solution or reaction of a gas in or with a liquid. Rotor and stator cylindrical members are mounted for rotation relative to one another and have opposing surfaces spaced to form an annular processing passage. The gap distance between the opposing surfaces and the relative rotation rate of the cylindrical members are such as to form a gas-in-liquid emulsion. Holl is thus directed to a process for mixing a gas and a liquid into an emulsion to increase the contact between the gaseous and liquid components rather than forming a thin film with a large surface area.

U.S. Pat. No. 6,512,131 to Best, et al. discloses a process for carrying out a multi-phase reaction in a continuously operated tube reactor with a liquid phase flowing downwards as a thin film in said tube reactor and components of a continuous gas flowing upward in said tube reactor are brought to material transfer, or reaction respectively. Best uses gas pressure modulation to maintain the thin film and thus does not rotate the tube to provide or maintain the thin film nature of the liquid phase of the reaction. Further, Best does not provide for the separation of multiple products in an integrated separation reservoir.

U.S. Pat. No. 4,675,137 to Umetsu discloses a method for producing a polyacetylene film by introducing acetylene gas into a vessel for storing Ziegler-Natta catalyst to polymerize the acetylene gas with the catalyst. Rotating the vessel coats the side wall with the catalyst. Thus, the acetylene gas introduced into the vessel is polymerized with the catalyst to produce the polyacetylene film. Umetsu's method is not a continuous process and the catalyst is not immobilized.

U.S. Pat. No. 4,353,874 to Keller, et al. discloses a rotary tube reactor, having at least one treatment line composed of tubes with individual sections having gas chambers that are sealed from each other. Each section has a gas outlet and adjacent sections are joined together by material passages. The reactor is used for thermal treatment. Keller relies on multiple tubes to transport reactants within the rotating tube and does not form a thin film on the inner surface of the rotating tube.

U.S. Pat. No. 4,335,079 to Vander Mey discloses an apparatus for a continuous process which comprises introducing a liquid onto a spherical rotating reaction surface as a thin film and rotating the reaction surface at a velocity such that the thin film is continuously moved toward the periphery of the reaction surface. Vander Mey divides the reaction surface into a plurality of areas and deposits within each area a controlled quantity of gas over the liquid film. A sub-atmospheric pressure is maintained while the temperature of the reaction surface is controlled. The reaction product moves to the periphery of the reaction surface by centrifugal action and the reaction product is continuously collected. Vander Mey is directed specifically toward reacting a thin film with a gas. Further, Vander Mey relies on a spherical reaction surface to move the film toward the product collection element and does not discuss the separation of multiple products.

U.S. Pat. No. 4,311,570 to Cowen, et al. discloses chemical processes using thin films of reactants carried out on the surface of a body rotating at high speed. The solid and insoluble liquid products are isolated by using centrifugal force to fling the products from the rim of the body into the surrounding atmosphere. Thus, Cowen relies on products that are solid, such as fibers or powders, or liquids that are incompatible with other products for separation. Further, Cowen requires that-at least part of the reaction surface of the reactor be inclined with respect to the axis of rotation.

Therefore, a reactor or thermal processor that utilizes a rotating tube to create a thin film of process components for a continuous reaction is desired. Further, a reactor or thermal processor that utilizes an improved separation means is desired.

### SUMMARY OF THE INVENTION

The invention comprises, in one form thereof, a thin film tube reactor, including an elongate tube that is rotatable about its longitudinal axis. A mixing plate rotatable about the tube's longitudinal axis may be positioned within the tube near the inlet. A plurality of fluid process components are fed into the tube and directed toward the mixing plate. In the absence of the mixing plate, the process components are directed toward the inner surface of the tube. Heating and cooling elements surround the tube to control the process temperature at particular points along the tube. A structured surface that is integral with or affixed to the inner surface of the tube immobilizes a catalyst slurry applied to the inner surface. A separation reservoir includes an end plate with a plurality of radially spaced outlet ports for controlling the output of the products from the separation reservoir. The invention is especially suited for such reaction types as photoprocessing, reactive distilling, and stripping processes.

An advantage of the present invention is that the rotating tube creates a thin film of process components for a continuous reaction.

A further advantage of the present invention is that the separation of components in the film occurs in the outlet section of the invention to minimize downstream processing. Also, the separation reservoir may be integral with the reactor such that the invention provides a continuous reaction and separation in a single enclosed module. A particular advantage of an integral separation reservoir is that as the products are removed from the system, unspent reactants continue to react to form additional products, thereby reducing the waste of unspent reactants.

An even further advantage of the present invention is that the thin film has a low thermal inertia for rapid temperature changes and allows simplified exposure to electromagnetic fields. The thin film further allows all constituent components to be rapidly mixed on the molecular level and the shear stresses applied to the thin film by the rotating tube further promote mixing. The thin film has a large surface area and therefore there is excellent contact between a gaseous component and the film.

A still further advantage of the present invention is that several tube reactors may be connected in series wherein the separate tube reactors may have different processing parameters such as angular velocity and diameter.

### BRIEF DESCRIPTION OF THE DRAWINGS

The above-mentioned and other features and advantages of this invention, and the manner of attaining them, will become apparent and be better understood by reference to the following description of particular embodiments of the invention in conjunction with the accompanying drawings, wherein:

FIG. 1A is a schematic of a tube reactor of the present invention;

FIG. 1B is a schematic of one configuration of the input of FIG. 1A;

FIG. 2A is a schematic of the tube reactor of FIG. 1A having output passages and a drive wheel;

FIG. 2B is a schematic of the tube reactor of FIG. 2A having a weir configuration;

FIG. 3 is a schematic of multiple tube reactors connected in series;

FIG. 4 is a schematic of the tube reactor of FIG. 1A having heating and cooling elements;

FIG. 5 is a sectional view of the tube reactor with a structured surface for immobilizing a catalyst element;

FIG. 6 is a schematic of a tube reactor configured for controlling the residence time of a slow moving film; and

FIG. 7 is a cross-sectional view of a tube reactor having a plurality of reaction surfaces.

Corresponding reference characters indicate corresponding parts throughout the several views. The examples set out herein illustrate particular embodiments of the invention but should not be construed as limiting the scope of the invention in any manner.

### DETAILED DESCRIPTION

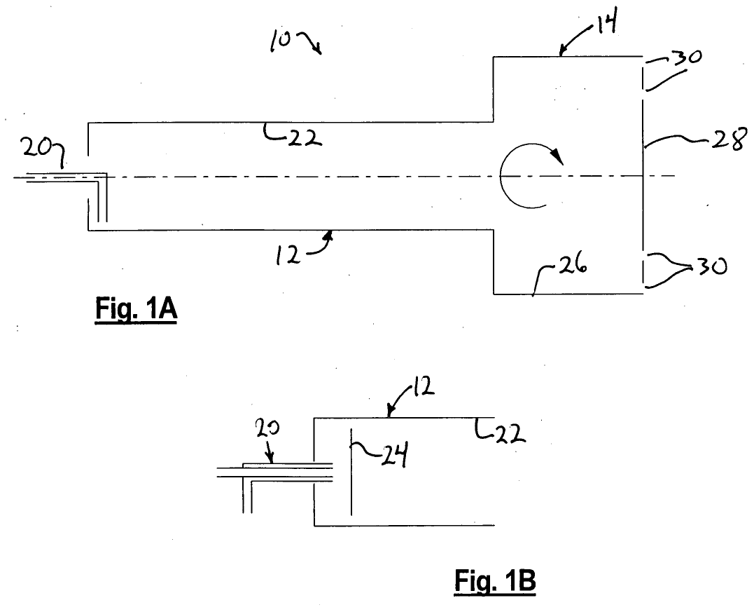

Referring to FIG. 1A, there is shown the thin film tube reactor of the present invention. The tube reactor 10 includes a primary tube 12, and a separation reservoir 14.

The primary tube 12 includes a feed tube 20 configured for depositing reactants onto an inner surface 22 of the primary tube 12. Alternatively, one or more feed tubes 20 configured in an array or coaxially as shown in FIG. 1B direct reactants toward a rotating mixing plate 24. The mixing plate 24 may be circular or any other shape. This adaptation allows rapid mixing of the reactant streams and is particularly suited for processes which require the mixing of reactants of different viscosities or the mixing of steams with vastly different flow rates. The centrifugal force then transfers the fluid from the mixing plate 24 to the inner wall 22. The surface of the mixing plate 24 may include structures to improve the hydrodynamics of the thin film on the surface. For example, a spiral structure on the surface of the mixing plate 24 may slow the outward flow of the thin film.

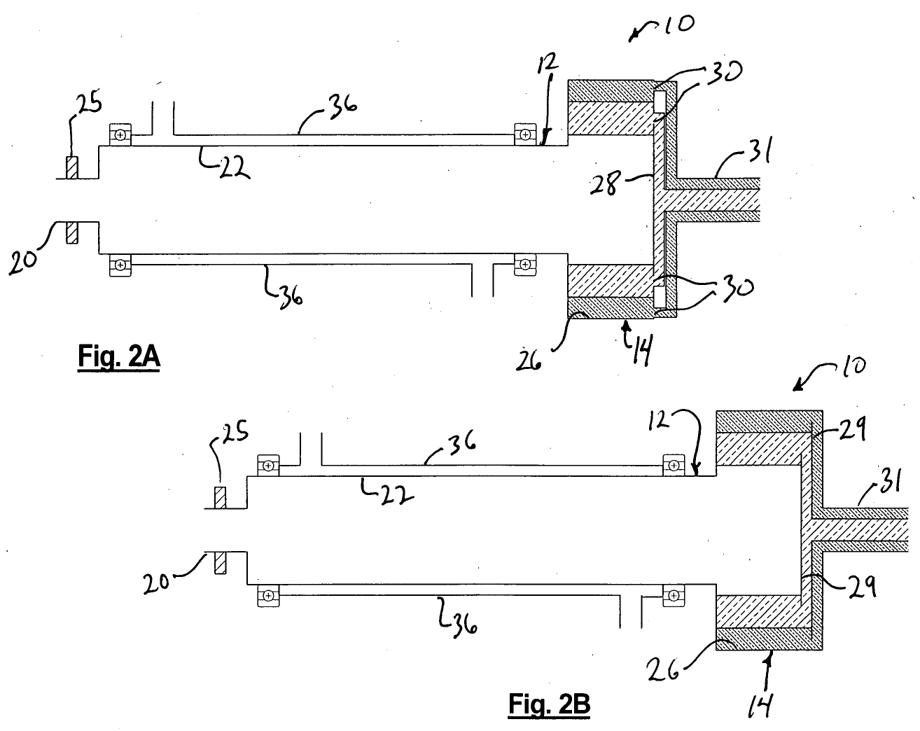

The primary tube 12 is rotated by a motor, which, in one embodiment, is coupled to a drive wheel 25 by a timing belt. Alternatively, the drive wheel 25, shown in FIG. 2A, is driven by gears in communication with the motor or the primary tube 12 is connected to the drive shaft directly. The interface between the feed tube 20 and the primary tube 12 may be a clearance fit or a sealed bearing to allow the primary tube 12 to rotate while the feed tube 20 does not.

The reactants are fed to the feed tube 20 by a method suited to the properties of the reactants. For example, a screw feed hopper may be used to deliver certain solids and liquids. A pneumatic delivery system may be used to deliver certain solids. Fluids may be delivered by a pump system.

The separation reservoir 14 includes a reservoir inner wall 26 and an end plate 28. The end plate 28 forms a plane that is substantially perpendicular to the axis of rotation and includes two or more radially spaced outlets 30. Each of the outlets 30 are positioned and sized such that the stream that exits through a particular outlet has a particular concentration of one component of the fluids and/or solids in the separation reservoir 14. FIG. 2A shows a plurality of outlet passages 31 in fluid communication with the outlets 30. In a particular embodiment shown in FIG. 2B, weirs 29 are used to control output of the reaction products. Alternatively, a weir 29 may be used in conjunction with the end plate 28.

In a particular embodiment of the invention, a crossflow filtration membrane is incorporated into the reservoir inner wall 26. The membrane filter is configured to remove a particular mixture component in the separation reservoir. For example, the membrane filter may be hydrophilic, hydrophobic, or size selective to remove such components as water, oils, or certain particulates. Further, a dead-end filtration membrane may be incorporated into the channels 31 connected to the outlets 30.

Alternative filtration methods that may be incorporated into the tube reactor 10 include ultrafiltration, reverse osmosis, and nanofiltration. In ultrafiltration, a composite membrane is spiral-wound about a central axis and the feed is axially driven through the resultant ultrafiltration cylinder. The composite membrane used in ultrafiltration may be configured to retain such contaminants as solids, colloids, and large organic molecules. Reverse osmosis is a particularly fine filtration method that uses a semi-permeable membrane in a crossflow configuration to remove contaminants from fluids such as water, ethanol, and glycol. Reverse osmosis requires a pressure differential across the membrane. Nanofiltration is a reverse osmosis technique that uses a less discriminating membrane that allows certain ions such as Na+, K+, and Cl− to pass.

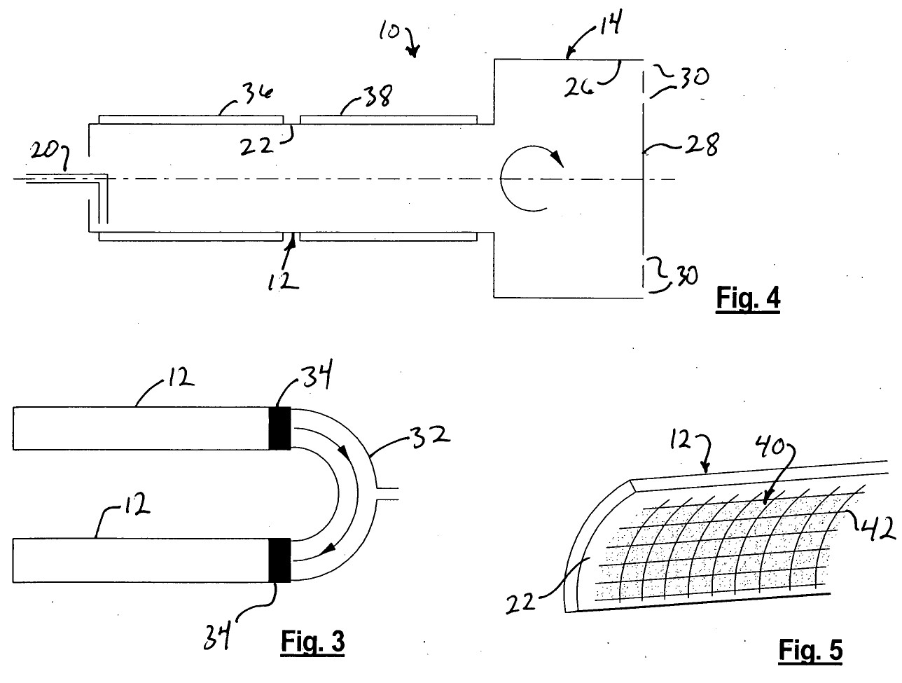

The separation reservoir 14 is in fluid communication with the primary tube 12; however, the separation reservoir 14 may be connected to the primary tube 12 through a coupling that allows the separation reservoir 14 to rotate at a different rate than the primary tube 12. Further, a plurality of primary tubes 12 may be connected in series as shown in FIG. 3. A reaction process may require that the primary tubes 12 each have different-diameters and axial velocities. The plurality of primary tubes 12 may be driven by a single drive system that is geared to drive each primary tube 12 at the axial velocity required by the reaction process. The primary tubes 12 are connected by non-rotating connecting pipes 32, each of which may connect two or more tube reactors 10. The connecting pipes 32 are coupled to the primary tubes 12 by a rotating to non-rotating union 34 that comprises a bushing or a bearing. Alternatively, a connecting pipe 32 is coupled to a primary tube 12 using a simple bearing with a seal. The connecting pipes 32 allow the introduction of additional components to the reaction process between tube reactors 10 as well as the removal of products and waste such as by the use of a separation reservoir 14. The advantage of using multiple tube reactors 10 is that the parameters of each tube reactor 10 may be configured so that the system of reactors achieves the required hydrodynamic regime according to the process requirements.

In a particular embodiment shown in FIGS. 2A, 2B, and 4, one or more heating jackets 36 and cooling jackets 38 are applied to the primary tube 12 for controlling the reaction temperature. Further, since the fluids in the primary tube 12 form a thin film on the inner surface 22, the fluids have a low thermal inertia. Thus the fluids in the primary tube 12 may be rapidly heated and cooled by heating jackets 36 and cooling jackets 38. Therefore, the tube reactor 10 is well suited for thermal processing and separation of components with or without a chemical reaction. The heating jackets 36 may comprise inductive, resistive, or conductive heat transfer elements. Alternatively, a heat transfer fluid is used. The heating jackets 36 and cooling jackets 38 may incorporate special heating structures to improve the thermal performance. Further, the inner surface 22 may incorporate structures that break down the boundary layer in the thin film to thereby increase the performance of the heat transfer. More particularly, surface roughness on the inner wall 22 causes more turbulent flow in the thin film. Thus, there is greater mixing of the thin film and the thermal boundary layer is reduced. A small thermal boundary layer indicates a small thermal gradient and improved heat transfer performance.

Further to modifying the inner wall 22, the outer surface of the primary tube 12 may be affected to improve the heat transfer between the wall and a heat transfer fluid. For example, surface effects such as fins may be included to increase the surface area of the outer surface. Also, the surface roughness of the outer surface may be configured to reduce the boundary layer of the heat transfer fluid to increase heat transfer.

It is often desirable to use a catalyst to initiate or speed up a reaction process. As shown in FIG. 5, a slurry of catalytically active solid particles 40 is immobilized on the inner wall 22 through the use of a structured surface 42 such as a mesh. The structured surface 42 is bonded or machined onto the inner wall 22 with substantially no passages between compartments in the mesh 42. The catalyst slurry 40 is passed through a non-rotating or a slowly rotating reactor until the catalyst slurry 40 has wetted the entire mesh 42. At this point, the rotational rate is increased to the reaction process velocity. The centrifugal force acts to hold the particulates in the catalyst slurry 40 in the pores of the mesh 42. The process fluid readily flows over the mesh 42 and contacts the catalyst slurry 40. The bed activity can be maintained by adding small amounts of catalyst slurry 40 to the feed 20. The entire catalyst slurry 40 is replaced by slowing the rotation of the tube reactor 10 and flushing the spent catalyst slurry 40 with a fluid. The new catalyst slurry 40 is then administered as described above. Alternatively, a catalyst that does not require frequent replacement is simply affixed to the inner wall 22.

Many processes require an external energy input such as electromagnetic radiation to promote the reactants to a state where reaction can take place. The tube reactor 10 is particularly well suited to exploit these field effects due to the hydrodynamics and scale of the film thickness. The film is sufficiently thin that almost complete saturation will occur. This ensures that all the reaction components will be exposed to substantially the same level of irradiation, which ensures good product uniformity and can be used to promote selectivity. As the tube reactor 10 is rotating it is not essential to illuminate the entire wall. By controlling the rotational rate, it is possible to ensure that the fluid passes through the zone of illumination as many times as is required by the process. Further, since the tube reactor 10 is hollow, the radiation source may be within the tube reactor 10 to thereby irradiate the thin film from inside the tube. This has the benefit of increased flexibility in the tube materials since the tube is not required to be transparent to the radiation.

The wall of the tube reactor 10 may be replaced entirely or in parts with transparent sections. This allows indirect and non invasive techniques to collect valuable data regarding the process conditions and degree of reaction. Such examples of these techniques include Raman spectroscopy and IR thermometry. The transparent sections may also be used to expose the fluid to sources of electromagnetic field radiation as described above.

The tube reactor 10 is particularly accommodating to a gaseous process component such as a catalyst or a reactant. The large surface area of the thin film provides excellent contact between the gas and the film. For example, a gaseous process component may be added to remove a particularly volatile component of the film in the form of a gas. Further, a vacuum device may be used to enhance the ability of the tube reactor 10 to remove unwanted components that will exit the thin film in the form of a gas when under negative pressure. Normally, the gasses are introduced or the vacuum is applied using a coaxial passage, however, other methods may be imagined by one skilled in the art. For example, a stationary manifold having a sealing engagement with a perforated portion of the primary tube 12 while allowing the primary tube 12 to rotate may be used to apply a vacuum or introduce a gas to the reactor 10. Alternatively, a rotating to non-rotating union 34 in communication with the primary tube 12 and/or the separation reservoir 14 may act as a manifold for applying a vacuum or introducing a gas.

In use, the process components are fed into the tube reactor 10 through the feed tubes 20. For process components that tend to mix well, a mixing plate 24 is not needed and the process components are directed toward the inner wall 22 as shown in FIG. 1A. The primary tube rotates at a particular velocity to form a thin film of the reactants on the inner surface 22. Further, shear stresses due to slippage between the inner wall 22 and the film enhance the mixing of the process components. Some process components need additional mixing and thus the mixing plate 24 may be included. In this case, the feed tubes 20 direct the process components toward the mixing plate 24, which rotates about the axis of rotation of the primary tube 12. The centrifugal force of the mixing plate 24 mixes the process components and forces them outward to the inner wall 22. As the process components are added to the inner wall 22 and the centrifugal force forms them into a thin film, previously added process components are forced out from under the newer components in the only direction available which is along the inner wall 22 toward the separation reservoir. As the components traverse the primary tube 12 they react with each other and any gas that may be present to result in the process products. Further, temperature control is affected by heating jackets 36 and cooling jackets 38 and any electromagnetic radiation required by the process is added to the thin film through the wall of the primary tube 12.

The products of the reaction process, and any remaining process components, build up in the separation reservoir 14 and the centrifugal force causes components of the separation mixture to separate. More particularly, the higher the density of a mixture component, the closer to the inner surface 26 that component resides in the separation reservoir 14. Since the composition of the separation mixture is known, the outlets 30 are radially spaced on the end plate 28 such that it is known which component exits through which outlet. In this manner waste products are separated from the useful products.

In the case that multiple tube reactors 10 are connected in series, the products of a first tube reactor enter the non-rotating connecting pipe 32 through the union 34. While products may be added and removed along the primary tube 12, the connection pipe 32 is convenient for products to be removed or additional reaction components to be introduced to the system. Subsequently, the components pass into a second tube reactor through another union 34 for the next stage of the process.

A more specific use of the invention is a heat treatment process for pasteurization. The pasteurization process requires that a volume of fluid is heated to a temperature and held for sufficient time that bacterial organisms are killed. Heating to a higher temperature reduces the time but can lead to protein denaturing. For example, milk pasteurization requires that the milk be maintained at a temperature of about 63° C. for at least about 30 minutes, 72° C. for at least about 16 seconds, or 138° C. for at least about 2 seconds. The primary tube 12 is surrounded by the heating jacket 36 and then the cooling jacket 38. The fluid, such as milk, is input to the rotating primary tube 12 through feed tube 20 and forms a thin film on the inner wall 22. The heating jacket 36 rapidly heats the thin film to the required temperature. A particular embodiment of the invention is capable of generating heat transfer coefficients over 8000 W/m²·K (Watts per square meter per degrees Kelvin). The thin film is then rapidly cooled by the cooling jacket 38 to prevent product denaturing. The fluid then enters the separation reservoir 14 where high fat content milk (cream) is separated from lower fat content milk (skimmed).

A further specific use of the invention is a method of ink jet toner preparation. In such a method, a polymer is dissolved in a volatile organic solvent to form an aqueous emulsion. Chemical additives are added and the emulsion is fed into the primary tube 12 through feed tube 20. A vacuum is applied to the reactor 10 as described above and a heating jacket 36 is included as shown in FIG. 2A. The organic phase is then removed from the aqueous phase and the emulsions become a suspension. The suspension flows into the separator section 14 where the solid phase tends towards the reservoir inner wall 26 and the aqueous phase more inner-wards. A slight outward taper of the separation reservoir 14 aids in the flow of the solids towards the end plate 28. The high solids phase is drawn out through the outlets 30 using a suitable pumping device such as a diaphragm pump.

A further specific use of the invention is a particular chemical reaction. In such chemical reaction, alkali is dissolved in a low order alcohol and the stream is fed onto the center of the mixing plate 24 through a feed tube 20 as shown in FIG. 1B. A stream of triglyceride is also fed to the mixing plate 24 through a separate feed tube 20. The mixing plate 24 acts to mix the streams and initiate reaction. The inner wall 22 of the primary tube 12 is heated by heating jacket 36 to further heat the reactants thereby increasing the reaction rate. The stream enters the separation reservoir 14 where a stream containing fatty acid derived methyl ester tends innermost, exiting the reactor 10 through the innermost outlets 30. The second product stream, exiting through the outermost outlets 30, contains glycerol, alkali catalyst, alcohol and soap.

An even further specific use of the invention is the mixture and reaction of two or more reactants that form an insoluble particle. Particularly, the feed tubes 20 co-feed two salt solutions, such as a sodium carbonate solution and a calcium sulfate solution, into the primary tube 12. The rotation of the primary tube 12 rapidly mixes the reactants while forming the mixture into a thin film on the inner wall 22. Within the thin film mixture, the two salt solutions exchange ions and during this exchange, the calcium ions and the carbonate ions combine to form fine particles of calcium carbonate. The products of the reaction enter the separation reservoir 14 where the centrifugal action causes the insoluble calcium carbonate particles to precipitate out from the product stream in a slurry. The calcium carbonate slurry is then easily removed from the reactor 10 through the outlets 30, separate from the other products of the reaction. The rapid mixing and the formation of the thin film put the salt solutions, and thus the different ions, in close proximity allowing an improved number of calcium ions to come into contact with carbonate ions. Therefore, the reactor 10 has an improved reaction efficiency for forming calcium carbonate particles.

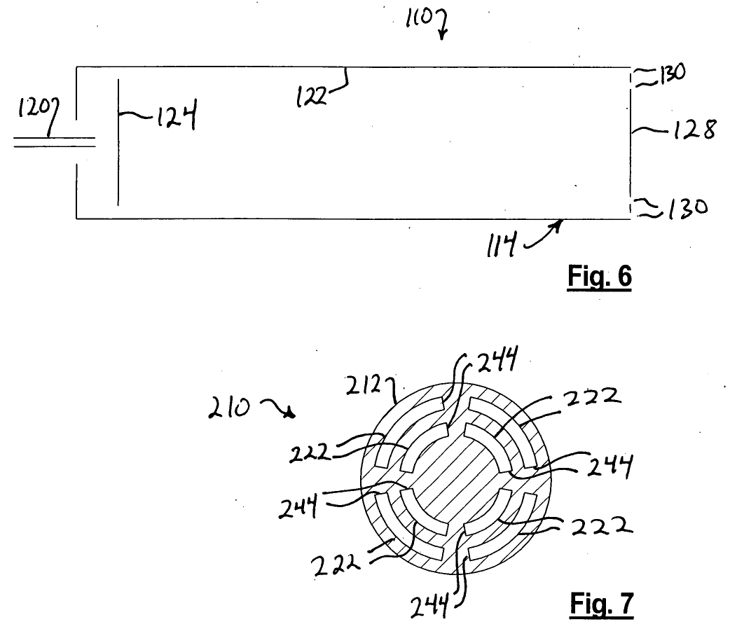

In a further embodiment shown in FIG. 6, a low rate tube reactor 110 is configured for a reaction process with inherently slow kinetics. The low rate tube reactor 110 produces a slow moving film with a controlled residence time. In this particular embodiment, the tube reactor 110 includes a straight separation section 114. The end plate 128 comprises two radially spaced exits 130. The exits 130 are situated in the end plate 128 or, alternatively, one exit 130 is located in the circular wall with one or more exits 130 in the end plate 128. This arrangement leads to thicker films than the tube reactor described in the previous embodiments and has the added advantage that a considerable amount of slippage will occur between the inner wall 122 and the inner most surface of the film. This creates another mixing regime and ensures that although the film is moving with a lower axial velocity, it is still experiencing significant shear stress.

The thickness of the film may be alternatively controlled using the reactor 10 with a separation reservoir 14 having a larger diameter than the primary tube 12 as described in the first embodiment. In this case, the reaction is initiated normally except that the products are not initially allowed to exit the separation reservoir 14. The components build up in the separation reservoir 14 and subsequently cause the film in the primary tube 12 to thicken. Once the desired thickness is achieved, the products are removed through the exits 30 at the same rate the reactants are fed to the primary tube 12. Thus, the desired film thickness is maintained.

In a further embodiment, the reactor 210 comprises several reaction surfaces 222 formed by channels 244 in a substantially symmetric rotating body such as a rotating cylinder 212. The cross-section of an example of such a reactor 210 is shown in FIG. 7. This configuration allows several separate reactions to run simultaneously in reactor 210. A multistage reaction may be accommodated by reactor 210 by merging two or more channels 244 at some point along the length of the reactor 210 to combine the products of the reactions in the merged channels 244 and start a second stage of the reaction in the new channel.

It should be particularly noted that a spinning disk similar to the mixing plate 24 of FIG. 1B may be sufficient to carry out certain thin film reactions, however, mechanical restrictions limit the residence time of reactants on such spinning disks. The addition of a rotating primary tube 12 according to the present invention may increase the residence time of the reaction while maintaining the proper hydrodynamics. The spinning disk may be driven by the same drive mechanism as the primary tube 12, a separate drive mechanism, or the feed tubes may be configured to supply the reactants and drive the spinning disk. The spinning disk may therefore spin at different rates in order to achieve the proper hydrodynamics of the reaction. Further, the spinning disk may be heated or cooled to improve the efficiency of the reaction.

It should be noted that the residence time of a reaction in the tube reactor 10 as shown in FIG. 1A may be calculated using the following formula from U.S. Pat. No. 4,311,570 to Cowen, et al. (Cowen):
t=((6πr²μl⁵)/(Q³f²ρ))^{1/4}
Where t is the residence time, ρ is the density of the liquid, μ is the viscosity of the liquid, Q is the volumetric feed rate of the liquid, and I is the length, r is the radius, and f is the rate of rotation of the primary tube 12 in revolutions per unit time. Further, the film thickness may be calculated for a measured residence time using the following formula, also from Cowen:
(Qt)/(2πrl)

It should be noted that although the invention has been described with a cylindrical tube, myriad tube shapes may be imagined for further embodiments of the invention. For example, a tapered primary tube 12 may be required to maintain the hydrodynamics of the reaction if the thin film changes viscosity as the reaction progresses. In a further example, it may be desirable to incorporate a tapered transition between the primary tube 12 and the separation reservoir 14. In an even further example, a tapered separation reservoir 14 may be desired for certain solids that tend to contact the reservoir inner wall 26. Such solids may not readily migrate to the end plate 28 unless the separation reservoir 14 is tapered.

While the invention has been described with reference to particular embodiments, it will be understood by those skilled in the art that various changes may be made and equivalents may be substituted for elements thereof without departing from the scope of the invention. In addition, many modifications may be made to adapt a particular situation or material to the teachings of the invention without departing from the scope of the invention.

Therefore, it is intended that the invention not be limited to the particular embodiments disclosed as the best mode contemplated for carrying out this invention, but that the invention will include all embodiments falling within the scope and spirit of the appended claims.

1. A thin film tube reactor, comprising:
a) an elongate tube having a longitudinal axis and an inner surface, and said tube being rotatable about the longitudinal axis;
b) means for supplying at least one fluid reactant to the inner surface;
c) means for removing a reaction product from said elongate tube that cooperates with a separation means.

2. The thin film tube reactor of claim 1, the supplying means comprising one or more feed tubes that direct the fluid reactant to the inner surface of said elongate tube.

3. The thin film tube reactor of claim 1, further comprising a mixing plate rotatable about the longitudinal axis and proximate to the supplying means, which comprises one or more feed tubes that direct the fluid reactant to the mixing plate.

4. The thin film tube reactor of claim 3, said elongate tube comprising a cylindrical tube and the mixing plate being substantially circular and coaxial with said elongate tube.

5. The thin film tube reactor of claim 3, the mixing plate having surface structures to affect the hydrodynamics of the reactant.

6. The thin film tube reactor of claim 1, wherein the rotation of said elongate tube causes the reactant to form a thin film on the inner surface of said elongate tube.

7. The thin film tube reactor of claim 1, said elongate tube being configured to process the reactant in a continuous process.

8. The thin film tube reactor of claim 1, the separation means comprising a rotatable reservoir having an end plate with a plurality of radially spaced outlets that have a radial position such that a known reaction product exits the separation means through each of the outlets.

9. The thin film tube reactor of claim 8, the separation reservoir comprising a filtration membrane that is selected from the group consisting essentially of a crossflow filtration membrane, a dead-end filtration membrane, an ultrafiltration membrane, a reverse osmosis membrane, and a nanofiltration membrane.

10. The thin film tube reactor of claim 8, the separation reservoir being coupled to said elongate tube such that the separation reservoir rotates at a different rate than said elongate tube.

11. The thin film tube reactor of claim 1, the separation means comprising a rotatable reservoir having a plurality of weirs at an outlet end, the weirs having a radial size such that a known reaction product exits the separation means by each of the weirs.

12. The thin film tube reactor of claim 1, further comprising a plurality of elongate tubes connected in series by non-rotating connecting pipes that are coupled to said elongate tubes by rotating to non-rotating unions; the connecting pipes having inlets for adding process components and outlets for removing process components.

13. The thin film tube reactor of claim 1, further comprising a heat transfer jacket surrounding said elongate tube; the heat transfer jacket being of the type selected from the group consisting essentially of inductive, resistive, conductive, and heat transfer fluid.

14. The thin film tube reactor of claim 1, further comprising a plurality of heat transfer jackets each configured to increase or decrease the process temperature along the length of said elongate tube.

15. The thin film tube reactor of claim 1, said elongate tube comprising surface structures on the inner surface for breaking down the boundary layer of the fluid reactant.

16. The thin film tube reactor of claim 1, the inner surface of said elongate tube comprising a structured mesh surface for immobilizing a reaction catalyst on the inner surface.

17. The thin film tube reactor of claim 1, further comprising an electromagnetic radiation source directed at a portion of said elongate tube.

18. The thin film tube reactor of claim 1, further comprising an electromagnetic radiation source within said elongate tube.

19. The thin film tube reactor of claim 1, said elongate tube comprising a transparent portion for indirect and non-invasive observation of a reaction.

20. The thin film tube reactor of claim 1, further comprising means for introducing a gas component to the reactant on the inner surface of said elongate tube; and means for removing an unwanted gas from said elongate tube.

21. The thin film tube reactor of claim 1, wherein said reactor is configured for a process selected from the group consisting essentially of a heat treatment process, an emulsion-forming process, a suspension-forming process, and a chemical reacting process.

22. The thin film tube reactor of claim 1, further comprising a plurality of reaction surfaces within said elongate tube, the reaction surfaces comprising a plurality of concentric channels formed in said elongate tube.

23. The thin film tube reactor of claim 1, said elongate tube comprising a tapered portion.

24. The thin film tube reactor of claim 1, the reactants comprising a sodium carbonate solution and a calcium sulfate solution, and the product comprising a plurality of calcium carbonate particles; wherein the calcium carbonate particles precipitate out of a mixture of process components in the separation means.
